(19) United States
(12) Patent Application Publication
(10) Pub. No.: US 2020/0076871 A1
(43) Pub. Date: Mar. 5, 2020

(54) WEB-BASED MOBILE APPLICATION FOR PROVIDING ON-SITE INSPECTIONS

(71) Applicants: Kingsley Obaji, Leesburg, VA (US); Magdalene Obaji, Leesburg, VA (US)

(72) Inventors: Kingsley Obaji, Leesburg, VA (US); Magdalene Obaji, Leesburg, VA (US)

(21) Appl. No.: 16/560,558

(22) Filed: Sep. 4, 2019

Related U.S. Application Data
(60) Provisional application No. 62/726,617, filed on Sep. 4, 2018.

(51) Int. Cl. H04L 29/08; H04L 29/06; G06F 16/95; G01S 19/01

(52) U.S. Cl. CPC H04L 67/02; H04L 65/4084; G01S 19/01; H04L 67/28; G06F 16/95

(57) ABSTRACT

An example method may include receiving a plurality of media content files associated with a site location, assigning metadata to the plurality of media content files, and determining whether the plurality of media content files and the assigned metadata fulfills one or more site inspection report requirements, and storing a site inspection report with the media content files and the assigned metadata at a server.

### CROSS-REFERENCE TO RELATED APPLICATIONS

This application claims priority to earlier filed provisional patent application No. 62/726,617 entitled “A WEB-BASED MOBILE APPLICATION FOR PROVIDING ON-SITE INSPECTIONS”, filed on Sep. 4, 2018, the entire contents of which are hereby incorporated by reference.

### TECHNICAL FIELD OF THE APPLICATION

This application relates to a mobile device application used to inspect on-site field locations, and more particularly, to an application which permits a mobile device to identify and capture media and append metadata and other information to the media for authentication according to third party standards.

### BACKGROUND OF THE APPLICATION

Conventionally, there are widespread opportunities to commit fraud and extort money and resources from large organizations and agencies, especially in times of great, are widespread. For example, hurricane Katrina, hurricane Sandy, floods in the Midwest, large-scale tornado events, etc., are all instances when the government, such as the Federal emergency management agency (FEMA), was forced to pay large sums of money to contractors in an effort to help those in need.

Another example is the Department for Housing and Urban Development (HUD). HUD has large-scale projects and obligations to various locations throughout the country. The HUD Office of Field Operations (OFO) provides and promotes the effective use of accurate, timely and reliable information assessing the condition of HUD's asset portfolio, to provide information to help ensure safe, decent and affordable housing, and to restore the public trust by identifying fraud, abuse and waste of HUD resources.

### SUMMARY OF THE APPLICATION

Example embodiments of the present application provide an example method which may include identifying a site requiring a site inspection, initiating an application to identify the site, capturing media content associated with the site, embedding metadata with the media content and finalizing the site inspection, and uploading the site inspection as a report to a remote server.

Another example embodiment may include a method that includes receiving a plurality of media content files associated with a site location, assigning metadata to the plurality of media content files, determining whether the plurality of media content files and the assigned metadata fulfills one or more site inspection report requirements, and storing a site inspection report comprising the media content files and the assigned metadata at a server.

Another example embodiment may include an apparatus that includes a receiver configured to receive a plurality of media content files associated with a site location, a processor configured to assign metadata to the plurality of media content files, determine whether the plurality of media content files and the assigned metadata fulfills one or more site inspection report requirements, and store a site inspection report comprising the media content files and the assigned metadata at a server.

Still yet another example embodiment may include a non-transitory computer readable storage medium configured to store instructions that when executed cause a processor to perform receiving a plurality of media content files associated with a site location, assigning metadata to the plurality of media content files, determining whether the plurality of media content files and the assigned metadata fulfills one or more site inspection report requirements and storing a site inspection report comprising the media content files and the assigned metadata at a server.

### BRIEF DESCRIPTION OF THE DRAWINGS

FIG. 1 illustrates an example network configuration for obtaining and reporting accurate, updated and compliant information according to example embodiments.

FIG. 2 illustrates an example user interface of an application used for an inspection that is conducted for compliance records according to example embodiments.

FIG. 3A illustrates an example flow diagram of a procedure for obtaining accurate site information according to example embodiments.

FIG. 3B illustrates another example flow diagram of a procedure for obtaining accurate site information according to example embodiments.

FIG. 3C illustrates an example flow diagram of a procedure for obtaining accurate site information and applying certain data requirements prior to committing the site data to an inspection site record according to example embodiments.

FIG. 4 illustrates an example photo image including a timestamp and location information that was recorded for site inspection purposes according to example embodiments.

FIG. 5 illustrates a user interface of an inspection site sequence for performing a site inspection according to example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments, the site inspection application operated by a field officer on his or her mobile device (e.g., smartphone, tablet, laptop, smartwatch, etc.) may capture, process and forward information that is accurate, credible and reliable for assessing a condition of a house(s) to update a HUD housing portfolio. For example, the application may facilitate field inspectors to collaborate and capture visual data from the field. The inspectors may visually collaborate among themselves, management and other professionals located at HUD central offices. By having accurate time, date, location, and related media (e.g., photos, video, etc.), the mobility inspection application will reduce fraud and operational costs for urgent, large-scale and otherwise unexpected events.

The mobile application is an integrated configuration that includes mobile devices, wireless access (WiFi/4G/5G, etc.), video conferencing, security solutions, visual data capture and enterprise data storage and reporting functions. The present application may support multiple user roles including, but not limited to inspector, manager, and administrator. The application may provide a capability for authenticated end-users to complete an online form, such as a HUD ‘52580’ inspection checklist form or other forms. Each question may have a ‘notes’ field and the ability to attach multiple files, including captured pictures and videos. When the attached file is a picture file (e.g., jpg, gif, png, pdf, etc.), the application may identify the date, timestamp, geolocation coordinate data, along with other metadata, such as inspector name, inspector identification number, and then superimpose and/or embed the data onto the uploaded images for accurate and legitimate records.

The application may support a HUD process for the HUD 52580 inspection checklist form where end-users can save drafts of the inspection form until he or she submits the form for management approval. from the manager's perspective, the application may provide the capability for the manager to review and approve submitted inspection forms. In addition, a manager can generate a statistical report identifying a number of forms in a draft state, pending approval state, and approved state. From the administrator perspective, the application may provide the capability to manage menu entries via one or more of create, read, update, and delete (‘CRUD’) screen options. Also, the application may log all user actions that involve data access and provide authentication measures to ensure the proper party has accessed/provided such information.

Additionally, the application may enable the inspector to capture pictures and/or video clips of the associated inspection to guarantee the inspection with date and time stamps, geolocation, and identification of the inspector, title of the image content (i.e., living room-637 12^{th} street). All such information may be embedded in the image(s) or picture(s) during the inspection process and included with the images during an upload procedure. The receiving application may identify each image received and copy the metadata and populate a database entry with the various fields and the title of images. The application may operate on iOS, WINDOWS, ANDROID, etc., operating system platforms. Access to the server for data repository purposes is accomplished over WiFi and mobile (4G, 5G, etc.) networks.

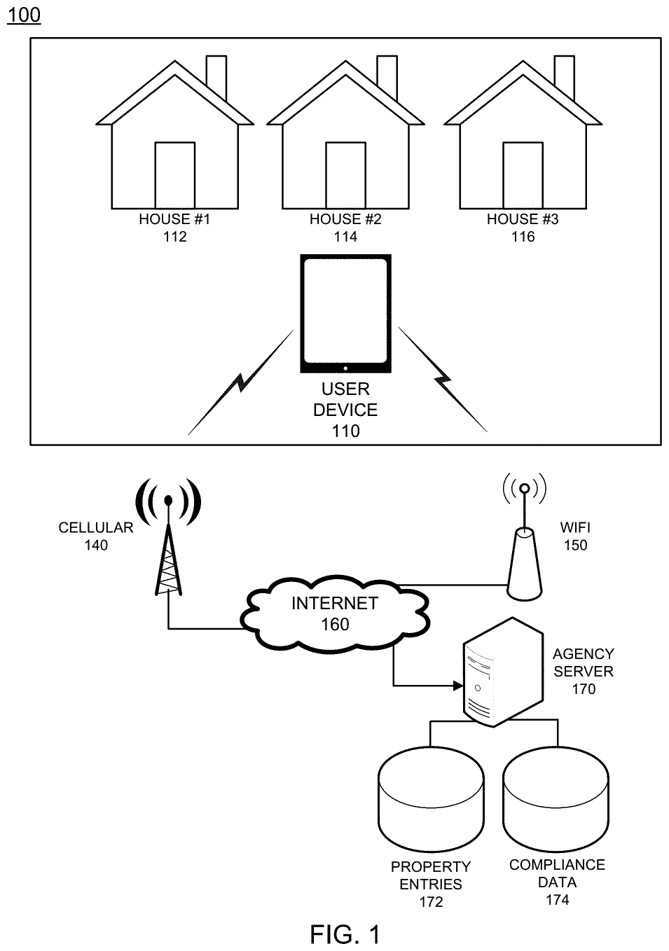

FIG. 1 illustrates an example network configuration for obtaining and reporting accurate, updated and compliant information according to example embodiments. Referring to FIG. 1, the network 100 includes a user device 110 operated by a field manager, which may include a smartphone, computer, laptop, tablet or any device with a processor and memory. The user device 110 may perform multiple inspections on multiple site locations, such as houses 112, 114, 116, etc. in a particular location. In operation, the field manager may take photos of rooms and areas on or around the houses to report current status information with timestamps, location and compliance information to a reporting agency.

As the information is collected in the form of images, video, spoken commentary and any other media, the information is uploaded via a local WIFI communication hub 150 and/or a cellular communication tower 140. The information may be passed through a network, such as the Internet 160 to a remote server site, such as an agency server 170. The information is retrieved/stored in one or more databases according to the content collected to reflect a particular site inspection. For example, each database property entry 172 may be for a different home address and must include timestamp, information for all rooms required to be inspected, and geolocation information performed via GPS or cellular triangulation location estimation. Forms, agency databases and other third party data sources may originate from a compliance data database 174.

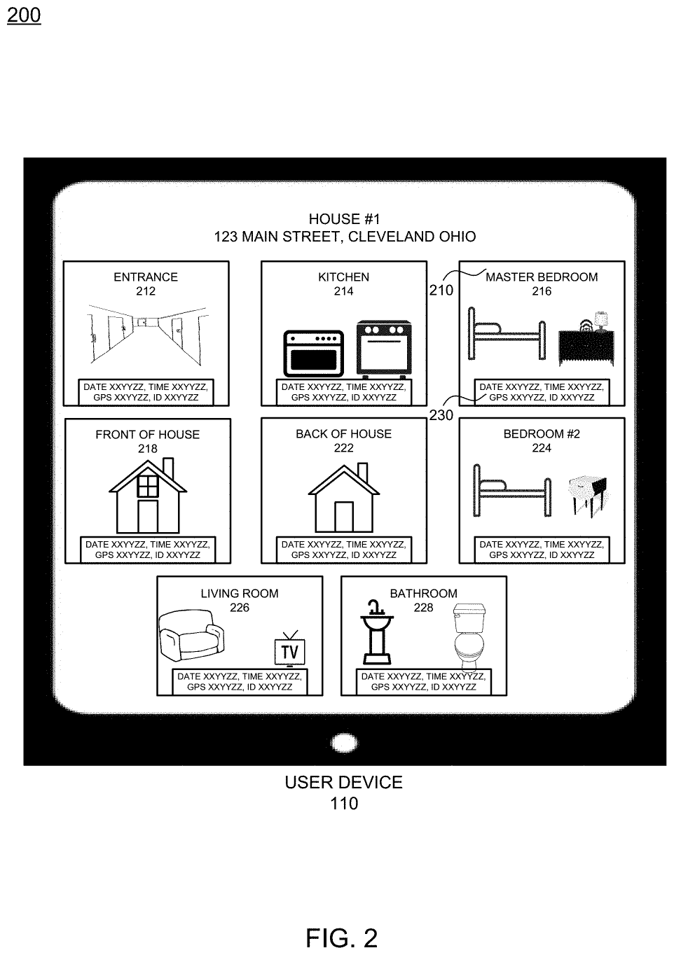

FIG. 2 illustrates an example user interface of an inspection being conducted for compliant record keeping according to example embodiments. Referring to FIG. 2, the example interface 200 may provide a series of images 210 for each room of the house along with the fingerprint/metadata information including, date, time, location, and identification of the device and/or a user account associated with the device for security. In this example, a particular home location includes eight images (212-228) representing each room and the front and back of a same house. The master bedroom is identified 210 at the top of the image and the fingerprint information 230 is identified at the bottom of the image. In other examples, the fingerprint information 230 may be at the top or side of the image or may be hidden and embedded in the image data for added security. The inspector may append as many images as needed and the list of rooms may be included in the form or known to the inspector. The images may capture all objects in the rooms, conditions of the objects, walls, floors, windows, ceilings, etc. for compliance with agency standards.

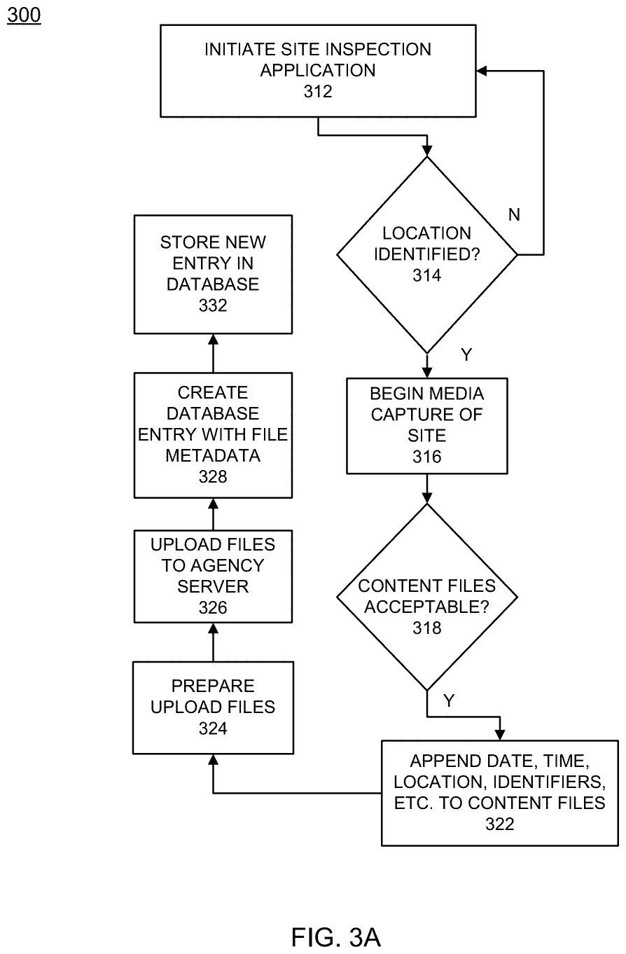

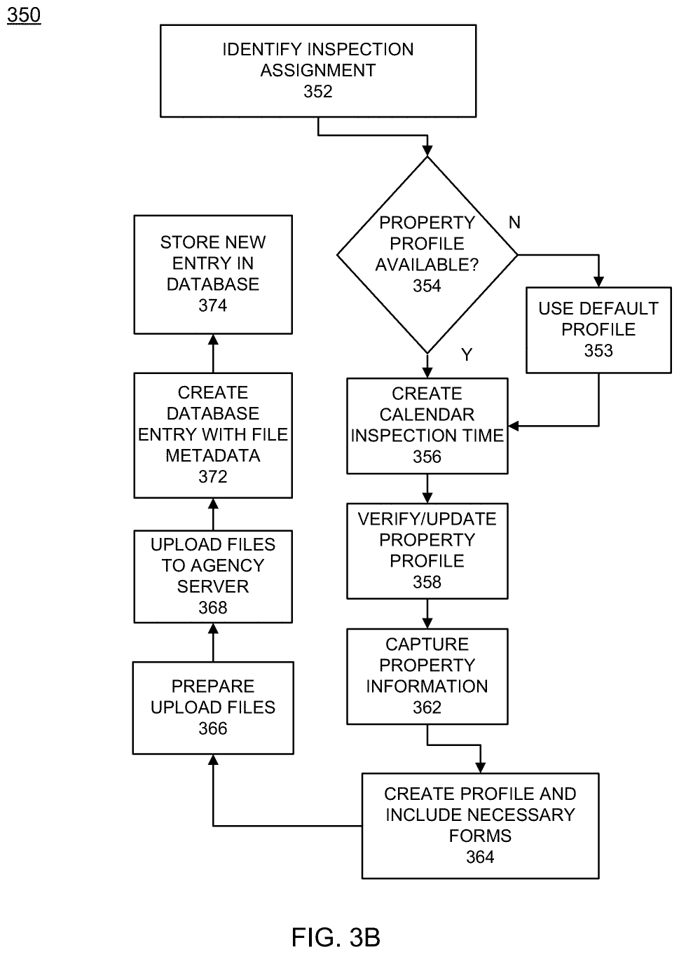

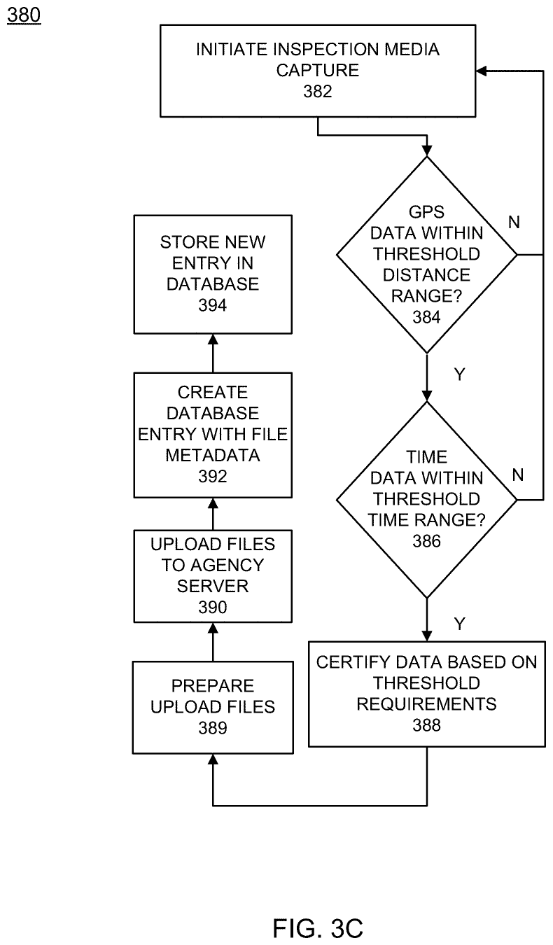

FIG. 3A illustrates an example flow diagram of a procedure for obtaining accurate site information according to example embodiments. In this example, the process 300 begins with a site inspection 312 being initiated on the computing device and a location being identified 314 prior to any images/media being logged for that particular site. The media may be captured 316 automatically or via manual operation of the device. The content may be identified as being acceptable or not via an image/media examination procedure 318, if the images are too dark or blurry the image processing process may reject the images and require additional images. Once the images are accepted the fingerprint/metadata information is appended to the content 322 and the inspection report is finalized 324 and uploaded to the agency server 326. The server may parse information and create database entries for each inspection report file received based on the metadata 328 associated with the images included in the master file. The information may be stored in a server/database 332.

FIG. 3B illustrates another example of an inspection process according to example embodiments. Referring to FIG. 3B, the process 350 provides identifying an inspection assignment 352 and attempting to retrieve a property profile 354 based on a third party property profile, such as a government entry for a particular address or private site that provides real estate information. If no profile is available, a default profile can be used 353 as a template that has its data populated. A calendar entry may be created to schedule the inspection date and time 356 or to identify the date the inspection occurred. A property profile may be created and/or updated 358 to include newly captured data 362. The profile may be created to include necessary forms for government compliance 364 and any specific profile information. The files are prepared and uploaded 366 to an agency server 368 for review and may include new database entries including certain file metadata 372 which can be used to categorize the database entry for a particular location, date and time. The entry may be stored in the database 374 for audit purposes.

FIG. 3C illustrates an example flow diagram of another process for ensuring compliance with a site inspection, according to example embodiments. Referring to FIG. 3B, the process 380 provides initiating an inspection media capture process 382. In this example, certain compliance measures may be used to ensure the integrity of the process. For example, an insurer or government agency may have an interest in ensuring the photos taken are of a particular home and/or location and not those of another site which could amount to fraud if images of one home are used to represent those of another home. One compliance measure may include identifying a GPS location and/or a time frame for conducting the site inspection. Once the inspection is initiated, the metadata appended to each media file may have a particular GPS location and time assigned to that particular media file. The next media files may also have a GPS location and time assigned. The process may include assigning metadata to each of the plurality of media content files with a current date, a current time, and current global positing satellite (GPS) location coordinates, and a unique identifier. A distance threshold may be used to identify a deviation each file may be permitted to have based on a threshold GPS coordinate deviation requirement which would prevent images from a certain distance away from being included in the current site inspection report. For example, the threshold distance range 384 may be 100 yards and if the GPS coordinates assigned to any of the files exceeds that threshold distance from any of the other files in the report, then those files may be disregarded from the inspection report. This may also include determining whether the plurality of media content files and the assigned metadata fulfills one or more site inspection report requirements, such as determining whether each inspection required room in a dwelling has been identified by one or more of the plurality of media content files. No rooms are permitted to be excluded from the report to ensure all expected rooms are included.

Another inspection security measure for ensuring accurate reporting may include determining whether the plurality of media content files and the assigned metadata fulfills one or more site inspection report requirements, such as a time requirement. This may provide determining whether each of a plurality of current times, identified from the metadata associated with each media content file of the inspection report are within a threshold time 386 of each of the other current times of the plurality of media content files. The time may be five minutes to ensure the media is not captured at a later time once the inspector has moved to a new site. When one or more of the plurality of GPS coordinates identified from the media files are logged and has exceeded the threshold distance (e.g., 100 yards) when compared with any of the other GPS coordinates of the plurality of media content files, then media content file with the GPS coordinates which exceed the threshold distance may be blocked from being included in the site inspection report. Similarly, when one or more of the plurality of current times, identified from the metadata associated with each media content file, exceeds the threshold time when compared with any of the other current times of the plurality of media content files, then that media content file with the current time which exceeds the threshold time may be blocked from being included in the site inspection report. Another approach may be a hybrid security measure where the images must have a threshold distance metadata requirement and time requirement and if either is exceeded for any of the media files captured, as compared to any others of the media files, then those images may be blocked from being submitted with the inspection report.

Once the data has passed the threshold requirement tests of distance and/or time, the data may be certified and submitted 388 to be included in the report. The files may be prepared and uploaded as part of the report file 389 to an agency database 390 and a new entry 392 may be created and stored 394 in the database.

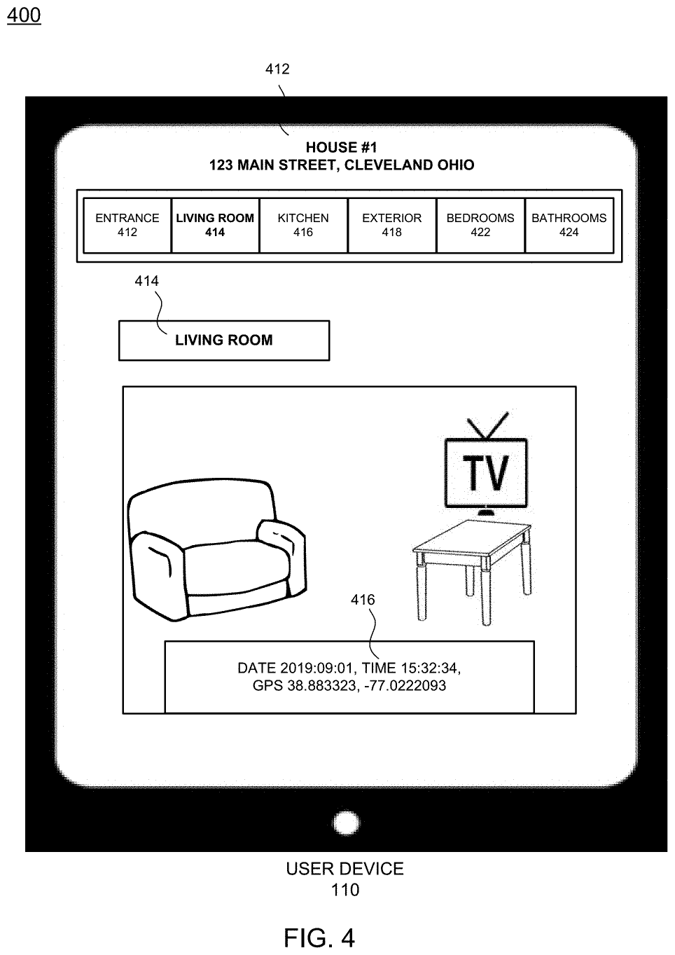

FIG. 4 illustrates an example photo image including timestamp and location information according to example embodiments. Referring to FIG. 4, the example 400 provides that the image data 412, for a particular room 414, includes content from a camera snapshot with an overlaid fingerprint of metadata 416 that includes, date, time and GPS coordinates as one example fingerprint, other data may include a unique identifier (not shown). As noted previously, the fingerprint information may be customized to accommodate standards for any agency and may include various other pieces of information.

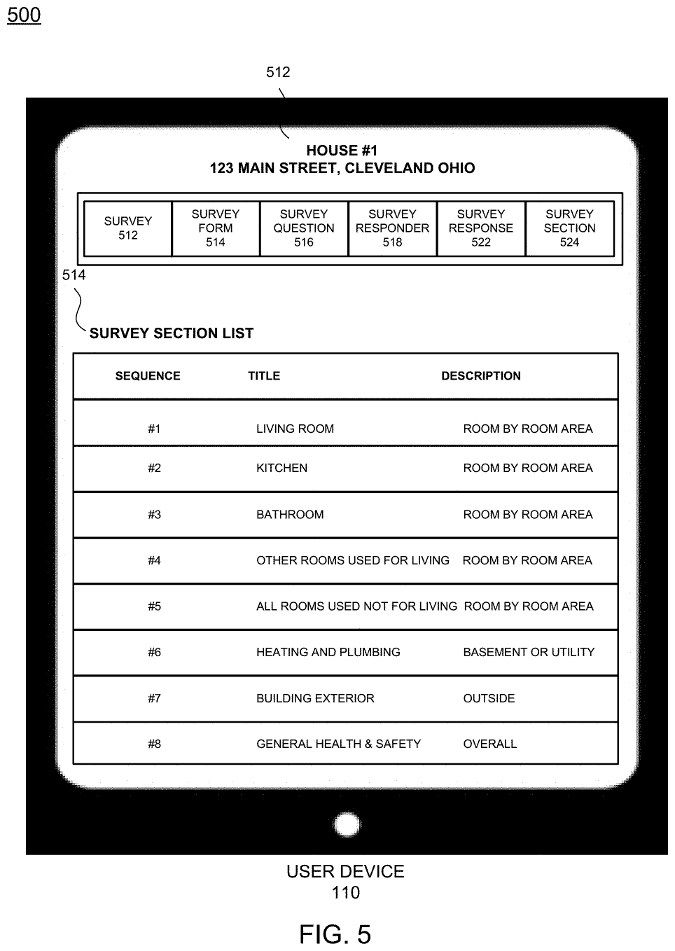

FIG. 5 illustrates a user interface of an inspection site sequence according to example embodiments. Referring to FIG. 5, the example user interface 500 includes a set of options 512 for navigating through menu options and customized information sources necessary to accommodate agency standards. In this example, the survey portion 514 includes a set of sequence images desired to be captured by the computing device for compliance during an inspection. The various examples include rooms, bathrooms, and hardware/mechanical infrastructure, such as heating and plumbing.

According to example embodiments, the application may be a web-based mobile application for WINDOWS, iOS and/or ANDROID operating systems. The user device may connect to the Internet via WiFi, 4G and/or other wireless protocols, performing an established inspection protocols and forms and collecting image, picture and/or video data captured into files, folders and forms. The data may be imbedded with date and time stamps along with the pictures and video clips as captured by the device, and also geolocation information to pictures and video clips as captured. Also, a voice overlay may be performed to captured data and video information along with data, image and video file sharing.

The application may provide secured access with a two-step authentication and data encryption process for a client server application platform. The mobile device may have the client software loaded and a server platform may be required for application data sharing and storage. The application may have a three-mode user platform for inspectors, managers and administrators. Data sharing between servers may be performed using ETL (i.e., extraction, transfer and load protocol). A server platform supports data warehousing and certain platforms used may include PhoneGap, Java/J2EE, Grails, JavaScripts, HTML, Burn Image Java Library, JQuery, Spring Core Framework, Spring Security, Spring Web Services, etc. A centralized user management, deployment, and monitoring platform may be used. Also, embedding of user identifications and property identifications, names and numbers may also be used, which provides the ability for remote removal of inspector data by an authorized administrator. The mobile application may be functional when a device is connected to the server. The mobile application may synchronize with a server when a connection is established between server and mobile device. The compression of data and transformation of forms, images and pictures to other formats, such as PDF may also be performed.

Videos and images captured in native JPG and GIF formats may also be required. The inspector will capture information as required by an inspection protocol. The manager will review and approve inspection data and images captured by an inspector. The administrator will create, read, update, delete screens. The application will support HUD UPCS standards and protocols and other proprietary standards and forms. A file on the mobile device can be deleted after download to a server. Password changes can be achieved only by the administrator. The application may support screen sharing and a video meeting, if necessary.

The mobile application is a web-based mobile application that enables home and property inspectors to complete an inspection process based on a given protocol, established checklist or forms. It supports various user roles to include the Inspector, Manager and Administrator. From the inspector perspective, applications provide the capability for the authenticated inspector to complete the checklist or form and capture associated pictures and video clips of the inspected environment. Pictures and video clips are captured in JPG and GIF formats and compressed to PDF as required. Every image or picture captured is imbedded with date and time stamp as well as geolocation data from the metadata. Property address or number, inspector name or number are additional information that can be automatically captured and imbedded onto the images and pictures. Each image or picture captured is automatically associated with the sections of the property inspected. In other words, if the living room is being inspected, the pictures or video clips captured for the living room are automatically imbedded in the living room folder for easy future retrieval. Where necessary, a voice overlay will be implemented so the inspector can have a brief voice recording of the inspections. The voice recording is converted to a “.wav” file and imbedded in the inspection folder for the property. The application may be provided as a service to customers as needed, including the device, the software application, the security, server, end user support, the management of the application and the software, the security of the device, can all be provided as a service, such as a cloud service.

From the manager perspective, the application will allow the manager to review, approve or disapprove the inspection. Once approved, the data on the system cannot be changed. From the Administrator's perspective, the application provides the capability to manage menu entries via Create, Read, Update, and Delete functions. From the Inspector perspective, the application will provide a capability for authenticated end-users to complete an online HUD 52580 Inspection Checklist Form. Each question shall have a Notes field and one or more attached files. When the attached file is a picture file (e.g., jpg, gif), the application shall extract the timestamp and geolocation data from the picture's metadata and superimpose the data onto the uploaded picture. The application shall support HUD business process for the HUD 52580 Inspection Checklist Form where end-users can save draft of the inspection form until he or she submit the form for management approval. The inspector will have the ability to work off-line where Internet access is not accessible. In this case, data synchronization will be achieved with the server once connectivity is re-established. From the Manager's perspective, the application shall provide the capability for manager to review and approved submitted inspection forms. In addition, a Manager can generate statistics report showing the number of forms in Draft state, Pending approval state, and Approved state. From the Administrator perspective, the application shall provide the capability to manage menu entries via Create, Read, Update, Delete (CRUD) screens. Also, the application shall log all user actions that involve data access. Future requirements may include developing (1) a Web services interface for all application capabilities and (2) a performance monitoring capability.

The application may support PhoneGap, Java/J2EE, Grails, JavaScript, HTML 5, Burn Image Java library, JQuery library, Spring Core Framework, Spring Security, Spring Web services and SQL Server. Other features include a mobile video teleconferencing and quality control tool to support OFO field inspections and the need to capture both picture and short video clips during inspections required for the super storm Sandy recovery. Our proposed business transformation solution will assist OFO in travel cost reduction and fraud control because the application will ensure the validity and authenticity of captured property inspection information. The pictures and short video clips captured during inspections (based on HUD 52580 Inspection Checklist) shall be imbedded with date, time stamp as well as location information, eliminating any fabrication of inspection information. The application is a web-based application that is accessible to end-user (field inspectors) via web browsers on desktop and mobile devices. The application shall provide HUD Inspectors with the capabilities to view and complete an online version of the HUD 52580 Inspection Checklist Form, where the user can attach multiple files (including pictures and short video clips) to each question section of the form.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

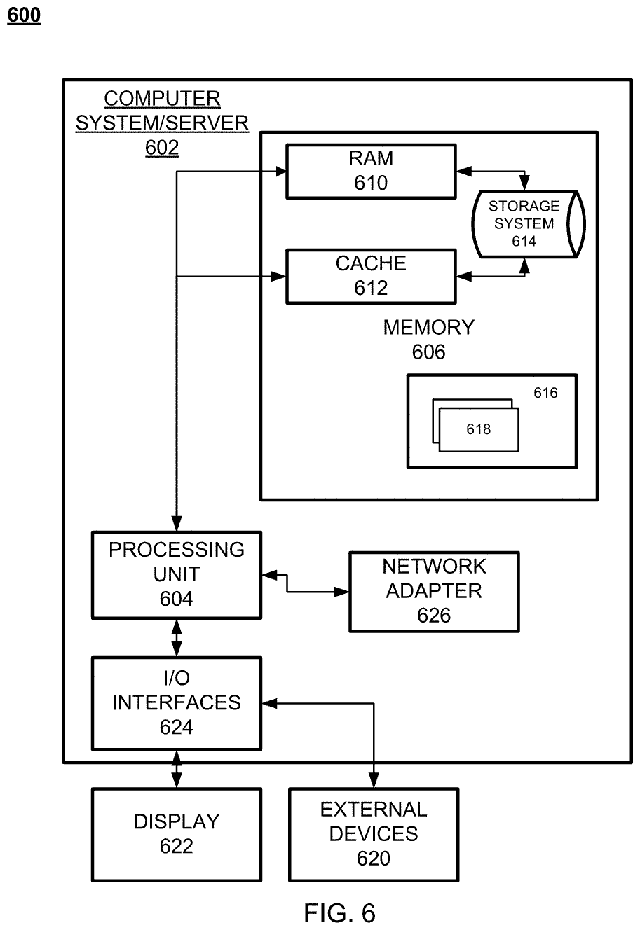

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 is not intended to suggest any limitation as to the scope of use or functionality of embodiments of the application described herein. Regardless, the computing node is capable of being implemented and/or performing any of the functionality set forth hereinabove.

In computing node 600 there is a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, memory 606 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility, having a set (at least one) of program modules, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 via a I/O adapter 624, such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624 of the adapter 626. Still yet, computer system/server 602 can communicate with one or more networks such as a local area network (LAN), a general wide area network (WAN), and/or a public network (e.g., the Internet) via network adapter. As depicted, adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

While example embodiments have been particularly shown and described, it will be understood by those skilled in the art that various changes in form and details may be made therein without departing from the scope of the embodiments encompassed by the appended claims.

What is claimed is:

1. A method comprising:
receiving a plurality of media content files associated with a site location;
assigning metadata to the plurality of media content files;
determining whether the plurality of media content files and the assigned metadata fulfills one or more site inspection report requirements; and
storing a site inspection report comprising the media content files and the assigned metadata at a server.

2. The method of claim 1, wherein the plurality of media content files comprise one or more of image files, video files, audio files, and text data files.

3. The method of claim 1, wherein the plurality of media content files correspond to a plurality of rooms of a dwelling.

4. The method of claim 1, wherein assigning metadata to the plurality of media content files comprises assigning each of the media content files a current date, a current time, current global positing satellite (GPS) location coordinates, and a unique identifier.

5. The method of claim 1, wherein determining whether the plurality of media content files and the assigned metadata fulfills one or more site inspection report requirements comprises determining whether each inspection required room in a dwelling has been identified by one or more of the plurality of media content files.

6. The method of claim 1, wherein determining whether the plurality of media content files and the assigned metadata fulfills one or more site inspection report requirements comprises:
determining whether each of a plurality of GPS coordinates, identified from the metadata associated with each media content file, are within a threshold distance of each of the other GPS coordinates of the plurality of media content files; and
determining whether each of a plurality of current times, identified from the metadata associated with each media content file, are within a threshold time of each of the other current times of the plurality of media content files.

7. The method of claim 6, wherein when one or more of the plurality of GPS coordinates, identified from the metadata associated with each media content file, exceeds the threshold distance when compared with any of the other GPS coordinates of the plurality of media content files, blocking the media content file with the GPS coordinates which exceed the threshold distance from being included in the site inspection report.

8. The method of claim 6, wherein when one or more of the plurality of current times, identified from the metadata associated with each media content file, exceeds the threshold time when compared with any of the other current times of the plurality of media content files, blocking the media content file with the current time which exceeds the threshold time from being included in the site inspection report.

9. An apparatus comprising:
a receiver configured to receive a plurality of media content files associated with a site location;
a processor configured to
assign metadata to the plurality of media content files;
determine whether the plurality of media content files and the assigned metadata fulfills one or more site inspection report requirements; and
store a site inspection report comprising the media content files and the assigned metadata at a server.

10. The apparatus of claim 9, wherein the plurality of media content files comprise one or more of image files, video files, audio files, and text data files.

11. The apparatus of claim 9, wherein the plurality of media content files correspond to a plurality of rooms of a dwelling.

12. The apparatus of claim 9, wherein the assignment of metadata to the plurality of media content files comprises assignment of each of the media content files a current date, a current time, current global positing satellite (GPS) location coordinates, and a unique identifier.

13. The apparatus of claim 9, wherein the determination as to whether the plurality of media content files and the assigned metadata fulfills one or more site inspection report requirements comprises a determination as to whether each inspection required room in a dwelling has been identified by one or more of the plurality of media content files.

14. The apparatus of claim 9, wherein the determination as to whether the plurality of media content files and the assigned metadata fulfills one or more site inspection report requirements comprises the processor being further configured to:
determine whether each of a plurality of GPS coordinates, identified from the metadata associated with each media content file, are within a threshold distance of each of the other GPS coordinates of the plurality of media content files; and
determine whether each of a plurality of current times, identified from the metadata associated with each media content file, are within a threshold time of each of the other current times of the plurality of media content files.

15. The apparatus of claim 14, wherein when one or more of the plurality of GPS coordinates, identified from the metadata associated with each media content file, exceeds the threshold distance when compared with any of the other GPS coordinates of the plurality of media content files, blocking the media content file with the GPS coordinates which exceed the threshold distance from being included in the site inspection report.

16. The apparatus of claim 14, wherein when one or more of the plurality of current times, identified from the metadata associated with each media content file, exceeds the threshold time when compared with any of the other current times of the plurality of media content files, the processor is configured to block the media content file with the current time which exceeds the threshold time from being included in the site inspection report.

17. A non-transitory computer readable storage medium configured to store instructions that when executed cause a processor to perform:
receiving a plurality of media content files associated with a site location;
assigning metadata to the plurality of media content files;
determining whether the plurality of media content files and the assigned metadata fulfills one or more site inspection report requirements; and
storing a site inspection report comprising the media content files and the assigned metadata at a server.

18. The non-transitory computer readable storage medium of claim 17, wherein the plurality of media content files comprise one or more of image files, video files, audio files, and text data files.

19. The non-transitory computer readable storage medium of claim 17, wherein the plurality of media content files correspond to a plurality of rooms of a dwelling.

20. The non-transitory computer readable storage medium of claim 17, wherein assigning metadata to the plurality of media content files comprises assigning each of the media content files a current date, a current time, current global positing satellite (GPS) location coordinates, and a unique identifier.
